(19) United States
(12) Patent Application Publication
(10) Pub. No.: US 2020/0326223 A1
(43) Pub. Date: Oct. 15, 2020

(54) PLASMA FILL SENSOR

(71) Applicant: KONINKLIJKE PHILIPS N.V., Eindhoven (NL)

(72) Inventors: Ravindra BHAT, EINDHOVEN (NL); Shashidharan ARPUTHA, BANGALORE (IN); Ravi Babu SUNDARAMOORYHY, BANGALORE (IN); Anil Shivram RAIKER, GOA (IN); Anthonie VAN DER LUGT, WAARLE (NL)

(21) Appl. No.: 16/094,063

(22) PCT Filed: May 17, 2017
(86) PCT No.: PCT/EP2017/061813

§ 371 Date: Oct. 16, 2018

(30) Foreign Application Priority Data
May 17, 2016 (EP) 16169920.2

(51) Int. Cl. G01F 23/292; G01V 8/12

(52) U.S. Cl. CPC G01F 23/292; G01V 8/12

(57) ABSTRACT

The present invention relates to blood analysis. In order to determine the filling level of a cartridge, a device (10) is provided that comprises a cartridge interface (14) for receiving a cartridge and a liquid level sensor (16). A cartridge position guiding arrangement is configured to engage with the cartridge for providing a six degree-of-freedom constraint to the cartridge. The liquid level sensor comprises a light source (18) and a light detector (20). The light source is configured to provide a beam of light (22) incident upon a cavity surface (24) of an optical pit (26) of a cartridge received by the cartridge interface. The light detector is configured to detect a portion (28) of the beam of light reflected from the cavity surface of the optical pit. The device is configured to determine a filling level of the optical pit based on the detected portion of the beam of light.

### FIELD OF THE INVENTION

The present invention relates to the field of blood analysis, and in particular to a device for determining the filling level of a cartridge based on light reflection, to an analyzer system, and to a method for determining the filling level of a cartridge.

### BACKGROUND OF THE INVENTION

Blood plasma separation is used in blood analysis for separating plasma from small volumes of blood e.g. in a range of 20 to 50 μl. The separated plasma, which is about 7-9 μl, fills up a cartridge, e.g. collected in an optical pit, for measuring molecule concentration. In order to ensure fool proof operation, it may be required to detect the filling of the cartridge. However, some methods, such as capacitive sensing described in U.S. Pat. No. 6,490,920 B1, may not be suitable for a miniature system for detecting a small volume of plasma, thus resulting in relatively complex analyzing setups.

EP 2483080B1 discloses an ink cartridge for inkjet printers with filled-level detection means arranged on a lateral surface. It provides a two side constraint to the cartridge, which is insufficient for accurate measurements, as the positioning of the cartridge is imperative to ensure accuracy in the measurements. The positioning of the cartridge is critical by way of precise and repeated positioning, affecting the accuracy. Since the prior art discussed herein provides only a two side constraints, the precise and repeated positioning is not achievable leading to error in measurements.

### SUMMARY OF THE INVENTION

There may be a need to provide a compact device suitable for determining a small sample volume.

The object of the present invention is solved by the subject-matter of the independent claims, wherein further embodiments are incorporated in the dependent claims. It should be noted that the following described aspects of the invention apply also for the device, for the analyzer system, and for the method.

In particular, in the following the device will be described with reference to the insertable cartridge. However, this device also applies to the analyzer system comprising the device and the insertable cartridge.

According to a first aspect of the present invention, a device is provided for determining a filling level of a cartridge based on light reflection. The device comprises a cartridge interface for receiving a cartridge and a liquid level sensor. The liquid level sensor comprises a light source and a light detector. The light source is configured to provide a beam of light incident upon a cavity surface of an optical pit of a cartridge received by the cartridge interface. The light detector is configured to detect a portion of the beam of light reflected from the cavity surface of the optical pit. The device is configured to determine a filling level of the optical pit based on the detected portion of the beam of light.

The term “cartridge”, as used herein, relates to a device that is used to collect a sample of body fluid, such as blood or saliva, which may e.g. have a dimension of 40 mm by 25 mm. A cartridge may be e.g. a disposable cartridge that fills itself from a sample fluid automatically. Such disposal cartridge may be constructed from transparent plastic components, e.g. made of acrylinc, without any moving parts or electronics. A cartridge may also be a disposable or non-disposable cartridge with moving parts or electronics on it to perform certain measurements or functions.

In this way, the liquid level sensor can be integrated in the device. Thus, a compact and ease-of-design analyzer system may be achieved.

According to an example, the light source is configured to provide a beam of light incident upon the cavity surface at an angle larger than a critical angle for total internal reflection at a cartridge substrate-air interface.

In this way, the portion of light received by the light detector is increased. This may also increase the signal-to-noise ratio.

According to an example, the liquid level sensor is a retro-reflective sensor with both the light source and light detector in one housing.

The arrangement of both light source and detector in the same housing may simplify the design.

According to an example, the light source and the light detector are arranged in the cartridge interface adjacent to a front surface of a transparent cartridge substrate of the cartridge when the cartridge is inserted into the cartridge interface of the device.

In other words, the light source and the light detector are arranged within a short distance to the front surface. This may reduce transmission loss and thus increase the signal-to-noise ratio.

According to an example, the device further comprises a through beam sensor with a transmitter and a receiver. The transmitter and receiver are arranged such that when the cartridge is inserted into the device, light beam transmitting from the transmitter to the receiver is interrupted to cause a change in the output status of the receiver for determining a presence of the cartridge.

Thus, the presence of the cartridge is detected by the device. Also, compared to mechanical limit sensor, the through beam sensor may provide a robust detection of the presence of the cartridge. Further, the non-contact detection may not cause any disturbance to the cartridge and thus the accuracy of detection may be increased.

According to an example, a portion of the cartridge is shaped to deflect incident light such that the cartridge appears opaque for the through beam sensor, when the cartridge is inserted into the cartridge interface of the device.

It is noted that a through beam sensor typically works with opaque light interceptors. However, the cartridge typically needs to be made of a transparent material for diagnosis, which implies that the material will not work as opaque light interceptors. The shaped portion of the cartridge thus may serve as a reflector to reflect the incident light and make the cartridge opaque to the receiver, when the cartridge is inserted into the device. In this way, the presence of the cartridge can be detected.

According to an example, the device further comprises a cartridge position guiding arrangement, which is configured to engage with the cartridge for providing a six degree-of-freedom constraint to the cartridge, when the cartridge is inserted into the device.

In this way, the cartridge may be precisely and repeatable positioned in the correct position for liquid level detection. Thus, the measurement errors due to non repeatable position may be reduced. Detection about the degrees of freedom can be gathered from Table 1 and the description.

According to a second aspect of the present invention, an analyzer system for molecule detection is provided. The analyzer system comprises a cartridge and a device according to one of the examples described above and in the following. The device is adapted for receiving the cartridge and configured to determine the filling level of the cartridge based on light reflection.

Thus, the filling level of the cartridge may be determined more precisely.

According to a third aspect of the present invention, a method is provided for determining the filling level of a cartridge. The method comprises the following steps:
a) receiving a cartridge;
b) providing a beam of light incident upon a cavity surface of an optical pit of the received cartridge;
c) detecting a portion of the beam of light reflected from the cavity surface of the optical pit; and
d) determining a filling level of the optical pit based on the detected potion of light.

This method essentially reflects the operating principle of the device and the analyzer system of the present invention.

According to an example, in step b) the beam of light is provided incident upon the cavity surface at an angle larger than a critical angle for total internal reflection at a cartridge substrate-air interface.

According to an example, step a) further comprises the step of:
a1) detecting a presence of the cartridge.

According to an example, step a) further comprises the step of:
a2) providing a six degree-of-freedom constraint to the cartridge, when the cartridge is inserted into the device.

According to an aspect of the present invention, a device (also referred to as optical engine) is provided for determining the filling level of a cartridge. The device comprises a liquid level sensor with a light source and a light detector to detect the filling level based on light reflection. Compared to other types of sensors, such as floats, capacitive sensing, the liquid level sensors based on light reflection may facilitate its integration into a miniature analyzer system. The device may optionally comprise a through beam sensor or optical slot sensor to detect a presence of the cartridge. A six degree-of-freedom constraint may be provided to achieve a precise repeatable positioning of the cartridge, when the cartridge is inserted into the device, which may improve the accuracy of the detection of the filling level of the cartridge.

These and other aspects of the present invention will become apparent from and be elucidated with reference to the embodiments described hereinafter.

### BRIEF DESCRIPTION OF THE DRAWINGS

Exemplary embodiments of the invention will be described in the following with reference to the following drawings:

FIG. 1 shows an example of a device for determining the filling level of a cartridge.

FIGS. 2A and 2B show an enlarged view of an example of a liquid level sensor.

FIGS. 3A to 3C show an example of a through beam sensor.

FIG. 4 shows an example of an analyzer system.

FIGS. 5A to 5C show different sectional views of FIG. 4.

FIG. 6 shows basic steps of an example of a method.

The figures are only schematically illustrated and not to scale. Same reference signs refer to same or similar features throughout the figures.

### DETAILED DESCRIPTION OF EMBODIMENTS

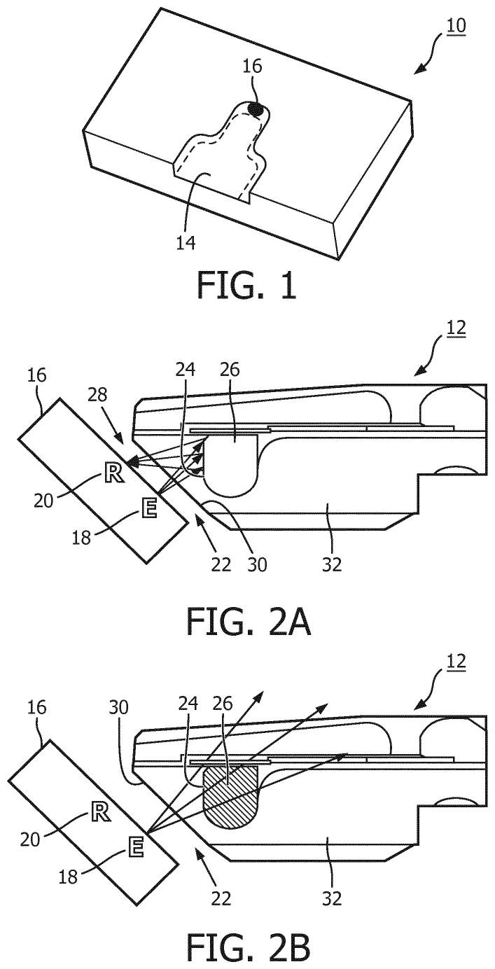

FIG. 1 shows an example of a device 10 for determining a filling level of a cartridge 12 (not shown in FIG. 1, see FIG. 2) according to an exemplary embodiment of the present invention. The device 10 comprises a cartridge interface 14 for receiving the cartridge 12 and a liquid level sensor 16.

The device 10 may also be referred to as optical engine, or optical engine unit, which relates to a unit of an analyzer system which is adapted for receiving a cartridge. The device 10 may comprise further sensors for providing certain measurements, for example, to measure the absorption of the liquid to determine e.g. the concentration of the molecule.

FIGS. 2A and 2B shows an enlarged view of the liquid level sensor 16 together with the cartridge 12 that is inserted into the cartridge interface 14 of device 10. The liquid level sensor 16 comprises a light source 18 and a light detector 20. The light source 18 is configured to provide a beam of light 22 incident upon a cavity surface 24 of an optical pit 26 of the cartridge 12. In an example, the light source 18 may provide a visible light, for example, in a wavelength range of 400 nm to 600 nm. In a further example, the light source 18 may provide an infrared light. The light detector 20 is configured to detect a portion 28 of the beam of light 22 reflected from the cavity surface 24 of the optical pit 26. The device 10 is configured to determine a filling level of the optical pit 26 based on the detected portion 28 of the beam of the light 22, e.g. through a computing unit on the device or through an external computing unit, such as a computer.

The term “optical pit”, as used herein, relates to a cavity in the cartridge substrate, which is used to collect a sample fluid for molecule detection.

Optionally, as shown in FIGS. 2A and 2B, the light source 18 and the light detector 20 are arranged in the cartridge interface 14 (not further shown) adjacent to a front surface 30 of a transparent cartridge substrate 32 of the cartridge 12 when the cartridge 12 is inserted into the cartridge interface 14 of the device 10.

The term “front surface”, as used herein, relates to the surface of the cartridge substrate with respect to the insertion direction of the cartridge.

FIG. 2A shows an example in which the optical pit 26 is empty. When the optical pit 26 is empty, the beam of light 22 reaches the cavity surface 24 between air and the cartridge substrate 14, a portion of light (in case of no total internal reflection) or the entire light (in case of total internal reflection) will be reflected and detected by the light detector 20.

FIG. 2B shows an example in which the optical pit 26 is filled with a sample fluid. When the optical pit 26 is filled with the sample fluid, which typically has a refractive index around 1.33, the conditions at the cavity surface 24 are changed. More light will be refracted and less light will be reflected and received by the light detector 20. In other words, the signal output of the light detector 20 is reduced. This can be detected by the device and the method of the present invention. To facilitate explanation of the present techniques, the reflected light is not illustrated, though it is to be understood that the reflected light also exists.

As a further option, as shown in FIG. 2A, the light source 18 and the whole analyzer system is configured to provide a beam of light incident upon the cavity surface 24 at an angle larger than a critical angle for total internal reflection at a cartridge substrate-air interface. In other words, the light source 18 and the cartridge 12 are provided relative to each other such that this criterion about the critical angle is met.

In other words, when the optical pit 26 is empty, since the refractive index in the optical pit (i.e. air) is lower than the cartridge substrate (e.g. plastic material) and the incident angle is greater than the critical angle, the beam of light 22 cannot pass through the cavity surface 24 and is entirely reflected, which is detected by the light detector 20. When the optical pit 26 is filled with a sample fluid, the beam of light 22 will be partially refracted at the cavity surface, and partially reflected.

In this way, a larger amount of light may be received by the light detector, thus increasing the signal-to-noise ratio.

FIGS. 2A and 2B show another option, in which the liquid level sensor 16 is provided as a retro-reflective sensor with both the light source 18 and the light detector 20 in one housing.

The term “retro-reflective” relates to an arrangement that places the light source and light receiver at the same location (in the same housing) and uses a reflector (i.e.

the cavity surface) to bounce the light beam, e.g. infrared, red or laser, back from the light source to the light detector.

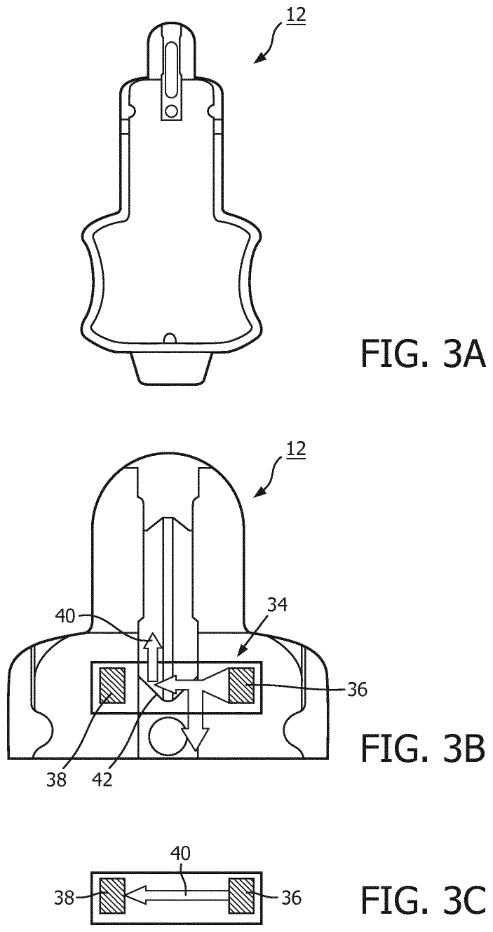

FIGS. 3A to 3C show an example of a through beam sensor 34 with a transmitter 36 and a receiver 38. The transmitter 36 and the receiver 38 are arranged such that when the cartridge 12 is inserted into the device 10, light beam 40 transmitting from the transmitter 36 and the receiver 38 is interrupted to cause a change in the output status of the receiver 38. The presence of the cartridge is determined based on the change in the output status of the receiver 38.

Optionally, a portion of the cartridge 12 is shaped to deflect incident light such that the cartridge 12 appears opaque for the through beam sensor 34, when the cartridge 12 is inserted into the cartridge interface 14 of the device 10. An example is provided in the following with reference to FIG. 3B.

In particular, FIG. 3A shows an example of the cartridge 12 before inserting into the cartridge interface 14 of the device 10.

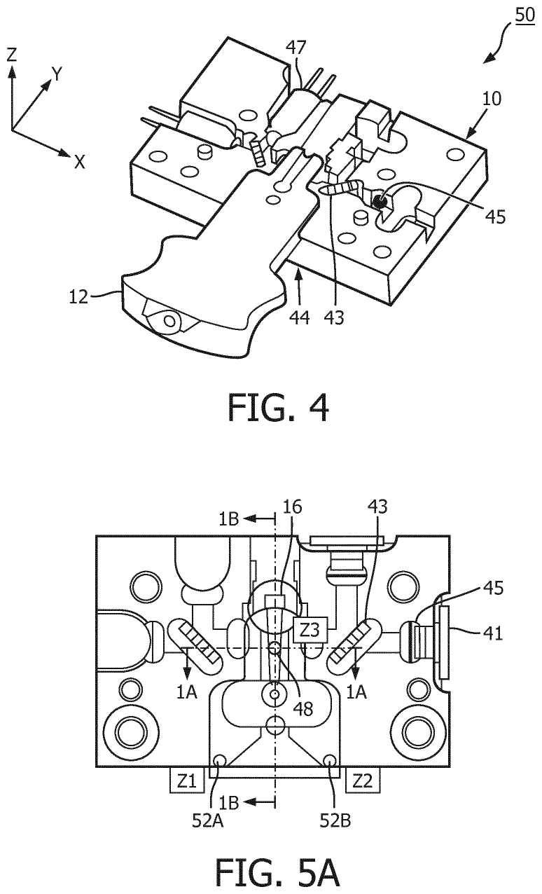

FIG. 3B shows that the cartridge 12 is received by the cartridge interface 14 (also see FIG. 4). The light beam 40 is blocked from getting to the receiver 38 from the transmitter 36 as a result of reflection or refraction by e.g. a wedge shaped portion 42 of the cartridge 12, and thus no light is able to reach the receiver 38. In other words, when a transparent material is given a wedge shape, the incident light gets reflected partly to one side and rest to the other side, thus appearing as opaque to the receiver.

FIG. 3C shows that when there is no cartridge in the cartridge interface 14, the light beam 40 transmitting from the transmitter 36 is entirely (or almost entirely) received by the receiver 38.

FIG. 4 shows an example of an analyzer system 50 according to an exemplary embodiment of the present invention. The analyzer system 50 comprises the cartridge 12 and the device 10 according to one of the examples described above and in the following. The device 10 is adapted for receiving the cartridge 12 and configured to determine the filling level of the cartridge 12 based on light reflection.

The term “analyzer system”, as used herein, relates to a biosensor platform to measure target molecules. The analyzer system may be e.g. a hand-held analyzer, which could be suitable for e.g. point-of-care testing. Besides the device, the analyzer system may comprise e.g. electromagnets, optical detection system, control electronics, software and read-out display.

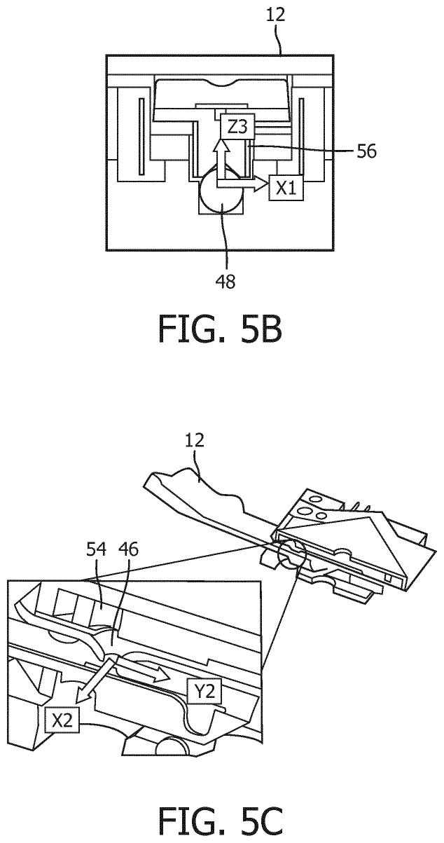

For example, the analyzer system 50 may be further configured to measure molecule concentration. In an example, as shown in FIG. 4 (also shown in FIG. 5A), the device 10 may further comprise a source (e.g. LEDs) aperture 41 to control stray light, dichroric mirrors 43 (e.g. two dichroric mirrors) to combine and then split the beam, narrow band (e.g. 10 nm) optical filters 45 and finally a light intensity measurement sensor 47. Thus, it is possible to use a light to frequency sensor where measuring the frequency will provide the light intensity. When this measurement is made once with and then without the fluid, it is possible to determine the absorption that in turn can be translated into concentration of the molecule.

As a further option, the device 10 may also comprise a cartridge position guiding arrangement 44 (not shown in detail in FIG. 4, see an example in FIGS. 5A to 5C). The cartridge position guiding arrangement 44 is configured to engage with the cartridge for providing a six degree-of-freedom constraint to the cartridge 12, when the cartridge 12 is inserted into the device 10.

The term “degree-of-freedom”, as used herein, relates to the number of independent movements the cartridge has, including e.g. translational and rotational movements. In FIG. 4, three translational directions—X, Y, and Z—are illustrated. In the following description, the X-, Y-, and Z-directions are also referred to as the first, second, and third translational directions, respectively.

The term “constraint”, as used herein, relates to a restriction on the freedom of movement of the cartridge. For example, a free body has six degrees of freedom, or possible motion. Each has to be stopped or constrained. Precise repeated location requires that these constrains (stops or contacts) are defined by design.

The constraint may ensure repeatedly positioning of the cartridge with improved precision. Thus, the accuracy of the detection of the filling level may also be improved.

FIGS. 5A to 5C show an example of the cartridge position guiding arrangement 44, which comprises a vacuum interface hemisphere 46, a ball 48, and two side constrains 52A, 52B.

FIG. 5A shows a top view of the analyzer system as shown in FIG. 5. The two side constraints 52A and 52B are provided in the cartridge interface 14 and arranged to couple to opposite sides of the cartridge to restrain the cartridge 12 in a third translational direction, i.e. Z-direction. These two constraints are also referred to as Z1 and Z2, respectively. Also shown in FIG. 5A is the ball 48 provided to restrain the cartridge 12 in the Z-direction, which is also referred to as Z3.

FIG. 5B shows a sectional view along a line 1A-1A shown in FIG. 5A. The ball 48 is positioned in the cartridge interface 14 and arranged to couple to a notch 56 of the cartridge 12 to restrain the cartridge 12 in the first translational direction, i.e. X-direction, and a third translational direction, i.e. Z-direction. The X constraint is also referred to as X1.

FIG. 5C shows a sectional view along a line 1B-1B shown in FIG. 5A. The vacuum interface hemisphere 46 is arranged in a cone 54 of the cartridge 12 for restraining the cartridge in the first translational direction, i.e. X-direction, and the second translational direction, i.e. Y-direction. The X constraint is also referred to as X2, and the Y constraint is also referred to as Y1.

The second translational direction, i.e. Y-direction, is an insertion direction along which the cartridge is inserted into the device. The first translational direction, i.e. X-direction, is perpendicular to the second translational direction and parallel to a surface extension. The third translational direction, i.e. Z-direction, is perpendicular to the first translational and the second translation directions.

The above set of constrains positions the cartridge 12 in all the linear degrees of freedom, i.e. X-, Y-, and Z-directions and rotational degrees of freedom, also referred to as Rₓ, R_{y}, and R_{z} as shown in Table 1.

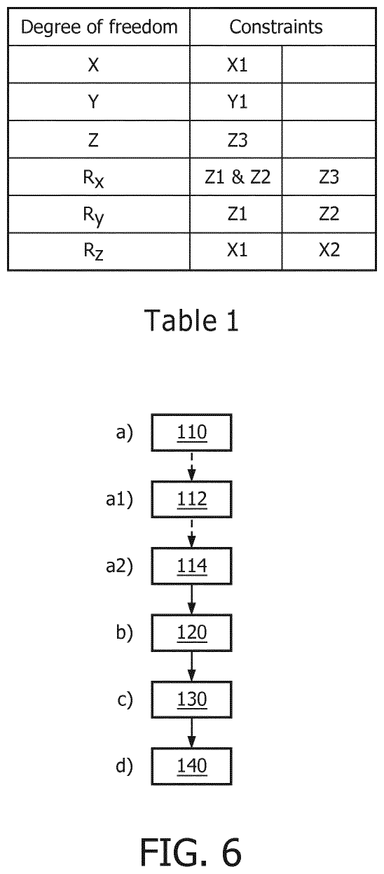

FIG. 6 shows basic steps of an example of a method 100 for determining the filling level of a cartridge. The method comprises the following steps:
In a first step 110, also referred to as step a), a cartridge is received, e.g. by a device as described herein.
In a second step 120, also referred to as step b), a beam of light is provided incident upon a cavity surface of an optical pit of the received cartridge.
In a third step 130, also referred to as step c), a portion of the beam of light reflected from the cavity surface of the optical pit is detected.
In a fourth step 140, a filling level of the optical pit is determined based on the detected potion of light.

In an example, in step b) the beam of light is provided incident upon the cavity surface at an angle larger than a critical angle for total internal reflection at a cartridge substrate-air interface.

As an option, indicated with a dashed arrow in FIG. 6, step a) further comprises the step of a1) detecting 112 a presence of the cartridge.

As a further option, also indicated with a dashed arrow in FIG. 6, step a) further comprises the step of a2) providing 114 a six degree-of-freedom constraint to the cartridge, when the cartridge is inserted into the device.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfil the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A device for determining a filling level of a cartridge based on light reflection, comprising:
a cartridge interface for receiving a cartridge;
a cartridge position guiding arrangement;
wherein the cartridge position guiding arrangement is configured to engage with the cartridge for providing a six degree-of-freedom constraint to the cartridge, when the cartridge is inserted into the device, and having a vacuum interface hemisphere, a ball and two side constraints to restrain the cartridge; and
a liquid level sensor;
wherein the liquid level sensor comprises a light source and a light detector;
wherein the light source is configured to provide a beam of light incident upon a cavity surface of an optical pit of a cartridge received by the cartridge interface;
wherein the light detector is configured to detect a portion of the beam of light reflected from the cavity surface of the optical pit; and
wherein the device is configured to determine a filling level of the optical pit based on the detected portion of the beam of light.

2. The device according to claim 1, wherein the light source is configured to provide a beam of light incident upon the cavity surface at an angle larger than a critical angle for total internal reflection at a cartridge substrate-air interface.

3. The device according to claim 1, wherein the liquid level sensor is a retro-reflective sensor with both the light source and light detector in one housing.

4. The device according to claim 1, wherein the light source and the light detector are arranged in the cartridge interface adjacent to a front surface of a cartridge substrate of the cartridge when the cartridge is inserted into the cartridge interface of the device.

5. The device according to claim 1, further comprising:
a through beam sensor with a transmitter and a receiver;
wherein the transmitter and receiver are arranged such that when the cartridge is inserted into the device, light beam transmitting from the transmitter to the receiver is interrupted to cause a change in the output status of the receiver for determining a presence of the cartridge.

6. The device according to claim 5, wherein a portion of the cartridge is shaped to deflect incident light such that the cartridge appears opaque for the through beam sensor, when the cartridge is inserted into the cartridge interface of the device.

7. The device according to claim 1, wherein the cartridge position guiding arrangement comprises:
a vacuum interface hemisphere;
a ball; and
two side constraints;
wherein the vacuum interface hemisphere is arranged in a cone of the cartridge for restraining the cartridge in a first translational direction and a second translational direction;
wherein the ball is positioned in the cartridge interface and arranged to couple to a notch of the cartridge to restrain the cartridge in the first translational direction and a third translational direction;
wherein the two side constraints are provided in the cartridge interface and arranged to couple to opposite sides of the cartridge to restrain the cartridge in the third translational direction;
wherein the second translational direction is an insertion direction along which the cartridge is inserted into the device; and
wherein the first translational direction is perpendicular to the second translational direction and parallel to a surface extension and the third translational direction is perpendicular to the first translational and the second translation directions.

8. An analyzer system for molecule detection, comprising:
a cartridge; and
a device according to claim 1;
wherein the device is adapted for receiving a cartridge and configured to determine the filling level of a cartridge based on light reflection.

9. A method for detecting a filling level of a cartridge, comprising the following steps:
a) receiving a cartridge, wherein receiving the cartridge comprises the step of
a2) providing a six degree-of-freedom constraint to the cartridge, when the cartridge is inserted into the device by a cartridge position guiding arrangement having a vacuum interface hemisphere, a ball and two side constraints;
b) providing a beam of light incident upon a cavity surface of an optical pit of the received cartridge;
c) detecting a portion of the beam of light reflected from the cavity surface of the optical pit; and
d) determining the filling level of the optical pit based on the detected potion of light.

10. The method according to claim 9, wherein in step b) the beam of light is provided incident upon the cavity surface at an angle larger than a critical angle for total internal reflection at a cartridge substrate-air interface.

11. The method according to claim 9, wherein step a) further comprises the step of:
a1) detecting a presence of the cartridge.
